(19) United States
(12) Patent Application Publication
(10) Pub. No.: US 2007/0033297 A1
(43) Pub. Date: Feb. 8, 2007

(54) All in one media center

(76) Inventor: Hsin-An Hsu, Taipei (TW)

Correspondence Address: CHARLES E. BAXLEY, ESQ., 90 JOHN STREET, THIRD FLOOR, NEW YORK, NY, 10038, US

(21) Appl. No.: 11/176,528

(22) Filed: Jul. 6, 2005

(51) Int. Cl. G06F 3/00; H04N 7/14

(52) U.S. Cl. 710/1; 348/14.01

(57) ABSTRACT

An all-in-one multi-media center includes a media housing having a front side, a rear side, and a functional rim extended between a peripheral edge of the front side and a peripheral edge of the rear side to form a receiving compartment within the front side, the rear side and the functional rim; a LCD screen provided at the front side of the media housing to define a planar direction; a central control unit supported within the receiving compartment to electrically connect with the LCD screen at the planar direction; a multi-media arrangement comprising a TV device and a computer device; and a supporting frame supported within the receiving compartment at a position between the LCD screen and the central control unit to substantially support the TV device and the computer device within the receiving compartment in a compact unit.

### BACKGROUND OF THE PRESENT INVENTION

1. Field of Invention

The present invention relates to an entertainment station, and more particularly to an all-in-one multi media center which combines a wide variety of multi media hardware for providing optimal entertainment to the user of the present invention.

2. Description of Related Arts

With the advance of information technology, domestic computers have been under dramatic development with faster and faster computing speed, and wider and wider fields of applications. As a result, more and more peripheral devices are incorporated with conventional computers so as to enhance their applications. For example, back to 1990s, hardware which produced sound effect and music is incorporated with the conventional computers so as to allow generating of sound during various applications, such as when the user is playing computer games.

More recently, there exist some widened types of computers which comprise a wide variety of peripheral devices, such as DVD players, MP3 players, mini hi-fi system, computer games joysticks, and the likes. While these technologies have effectively enhanced the range of application of conventional computers, and eventually fostered scientific and technological development of mankind as a whole, but this does not mean that those computers have no disadvantages and discrepancies in view of their applications.

The most pressing problem is that the more function the computer system has, the bigger the size it is. For example, if one is trying to watch DVD by his computer, he has to incorporate a DVD drive, whether it be an externally incorporated or internally built-in, into the computer system in order to perform the required function. As a result, the general size of the computer system would inevitably increase as compared with those conventional computer systems.

On the other hand, there is another problem which concerns the relationship between a conventional display unit, such as a CRT monitor or a LCD monitor, and a conventional central control unit in a conventional computer system. Specifically, for a conventional computer system, the monitor, whether it be a CRT or a LCD, is very often structurally separated from the central control unit, wherein their connection is by means of a plurality of easily-tangled transmission cables.

Thus one is facing a pressing problem characterized by the difficulty of separately allocating the two most bulky elements in a conventional computer system, i.e. the monitor and the central control unit. As a mater of fact, there exist a number of furniture or computer desks which are specifically designed to support a conventional computer system, wherein the computer desk usually comprises a main deck and a monitor deck for supporting the central control unit and the monitor respectively. However, it must be conceived that such computer decks or furniture are indeed at best bulky, if not wastefully excessive.

That is the reason why a typical computer system and a computer desk would take up a considerable amount of space. This problem is not really severe when the user has a really big room or office, so that a bigger structure is even more desirable. Moreover, for those who even need to struggle about an adequate space for sleeping or for dining, the huge space requirement for installing even a conventional computer system would mean that it is a luxury. At the same time however, being in this era of information and knowledge, a computer system is indeed more or less a necessity in even a developing country, not to mention the well-developed United States.

Finally, even though space is not a problem for a particular user, there involves an inevitable inconvenience for those who want a wide variety of multi-media entertainment or computer applications.

Thus, it is submitted, there exists a need to remedy the above-mentioned discrepancies.

### SUMMARY OF THE PRESENT INVENTION

A main object of the present invention is to provide an all-in-one multi-media center which combines a wide variety of multi media hardware, including an LCD monitor, in a single unit for providing optimal entertainment to the user of the present invention.

Another object of the present invention is to provide an all-in-one multi-media center comprising a housing which has a minimal depth wherein the plurality of multi-media hardware is disposed therein so as to minimize an occupying space of the present invention.

Another object of the present invention is to provide an all-in-one multi-media center which is adapted to be easily and conveniently carried and transported so as to substantially overcome the hassle in carrying and transporting bulky conventional computer systems.

Another object of the present invention is to provide an all-in-one multi-media center which is not only capable of performing sophisticated computing tasks but only providing a wide range of multi-media support in one single unit. In other words, the present invention substantially combines conventional computer systems and a wide variety of multi-media devices in a convenient, user-friendly and economical manner.

Another object of the present invention is to provide an all-in-one multi-media center which is capable of substituting domestic multi-media devices so that a user of the present invention no longer needs to install different multi-media devices separately so as to minimize his/her entertainment expense yet with a greater satisfaction.

Accordingly, in order to accomplish the above objects, the present invention provides an all-in-one multi-media center, comprising:

a media housing having a front side, a rear side, and a functional rim extended between a peripheral edge of the front side and a peripheral edge of the rear side to form a receiving compartment within the front side, the rear side and the functional rim, wherein the receiving compartment has a thickness between the front and the rear side;

a LCD screen provided at the front side of the media housing to define a planar direction;

a central control unit supported within the receiving compartment to electrically connect to the LCD screen at the planar direction;

a multi-media arrangement comprising a TV device and a computer device;

wherein the TV device comprises a television-tuner hardware, which is supported within the receiving compartment to electrically connected with the central control unit for processing television signal such that the central control unit is adapted for converting the television signal into an image signal to be displayed on the LCD screen, and two speakers supported at two side portions of the receiving compartment to electrically connect with the central control unit for converting the television signal into a sound signal;

wherein the computer device comprises a hard drive supported at a mid-bottom portion of the receiving compartment to electrically connect with the central control unit and a removable memory drive supported on one of the side portion of the receiving compartment to electrically connect with the central control unit, wherein removable memory drive has an access slot formed on the functional rim for allowing a memory disc communicating with the removable memory drive through access slot; and

a supporting frame supported within the receiving compartment at a position between the LCD screen and the central control unit to substantially support the TV device and the computer device within the receiving compartment in a compact unit so as to minimize the thickness of the media housing between the front and rear sides thereof.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an all-in-one multi-media center according to a preferred embodiment of the present invention.

FIG. 2 is an exploded view of the all-in-one multi-media center according to the above preferred embodiment of the present invention.

FIG. 3 is a sectional side view of the all-in-one multi-media center according to the above preferred embodiment of the present invention.

FIG. 4 is a perspective view of the detachable cover of the rear cover according to the above preferred embodiment of the present invention.

FIG. 5 is a rear perspective view of the all-in-one multi-media center according to the above preferred embodiment of the present invention.

FIGS. 6A and 6B are exploded views of the a pivotal hinge connecting between the media housing and the supporting arm in a pivotally movable manner according to the above preferred embodiment of the present invention.

FIGS. 7A-7C are exploded views of the hand-carrying device of the all-in-one multi-media center according to the above preferred embodiment of the present invention.

### DETAILED DESCRIPTION OF THE PREFERRED EMBODIMENT

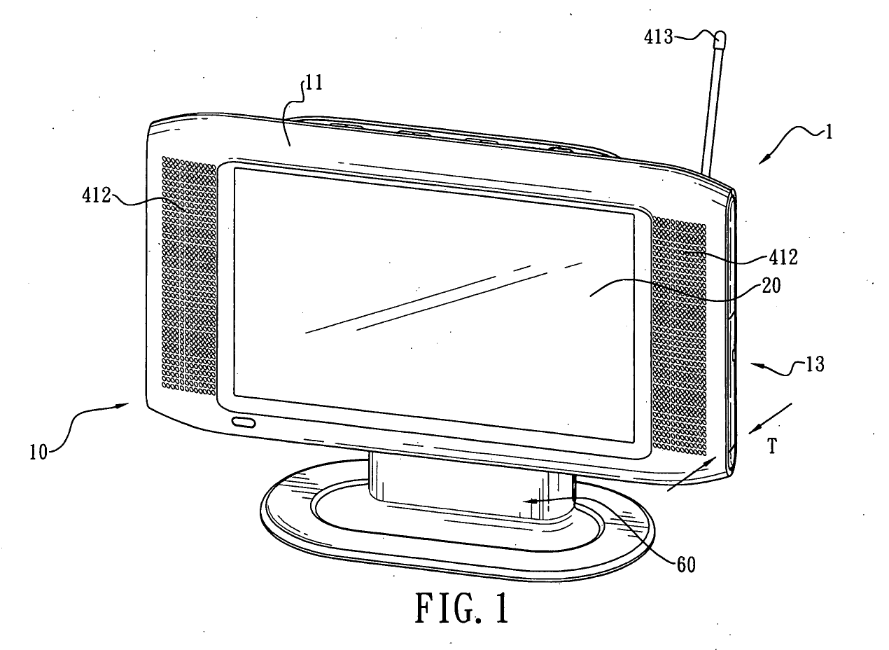

Referring to FIG. 1 to FIG. 3 of the drawings, an all-in-one multi-media center 1 according to a preferred embodiment of the present invention is illustrated, in which the all-in-one multi-media center 1 comprises a media housing 10, a Liquid Crystal Display (LCD) screen 20, a central control unit 30, and a multi-media arrangement 40, and a supporting frame 50.

The media housing 10 has a front cover 11, a rear cover 12, and a functional rim 13 extended between a peripheral edge of the front and the rear covers 11, 12 to form a receiving compartment within the front cover 11, the rear cover 12 and the functional rim 13, wherein the receiving compartment has a minimal thickness T between the front and the rear covers 11, 12.

The LCD screen 20 is provided at the front cover 11 of the media housing 10 to define a planar direction which is the transverse direction of the media housing 10 and the LCD screen 20. For example, within the planar direction, the media housing 10 and the LCD screen 20. Moreover, the central control unit 30 is supported within the receiving compartment to electrically connect to the LCD screen 20 at the respective planar direction.

The multi-media arrangement comprises a TV device 41 and a computer device 42, wherein the TV device 41 comprises a television-tuner hardware 411, which is supported within the receiving compartment to electrically connect with the central control unit 30 for processing television signal such that the central control unit 30 is adapted for converting the television signal into an image signal to be displayed on the LCD screen 20. The TV device 41 further comprises two speakers 412 supported at two side portions of the receiving compartment to electrically connect with the central control unit 30 for converting the television signal into a sound signal, and deliver the sound signal to an outside of the multi-media center 1 so as to produce a sound effect to the respective multi-media application.

According to the preferred embodiment, the computer device 42 comprises a hard drive 421 supported at a mid-bottom portion of the receiving compartment to electrically connect with the central control unit 30, an integrated media card reader 431 supported on one of the side portion of the receiving compartment to electrically connect with the central control unit 30, wherein the integrated memory card reader 431, such as 7 in 1 card reader (MS, MSPro, SD, MMC, CF, SM, Micro Drive), has an access slot formed on the functional rim 13 for allowing most of memory cards communicating with the integrated media card reader 431 through the access slot, and a removable memory drive 422 supported on one of the side portion of the receiving compartment to electrically connect with the central control unit 30, wherein the removable memory drive 422 has an access slot formed on the functional rim 13 for allowing a memory disc, such as a DVD (Digital Video Disc) or a VCD (Video Compact Disc), communicating with the removable memory drive 422 through the access slot.

The supporting frame 50 is supported within the receiving compartment at a position between the LCD screen 20 and the central control unit 30 to substantially support the TV device 41 and the computer device 42 within the receiving compartment in a compact unit so as to minimize the thickness T of the media housing 10 between the front cover 11 and rear cover 12 thereof.

The hinge supporting frame 51 is supported at a position between the central control unit 30 and the rear cover 12 to substantially support the media housing 10, the Liquid Crystal Display (LCD) screen 20, the central control unit 30, and the multi-media arrangement, and the supporting frame 50.

The front cover 11 of the media housing 10 further has a front screen opening formed thereon wherein the LCD screen 20 is supported in the receiving compartment and visually communicated with an exterior of the media housing 10 through the screen opening. According to the preferred embodiment, the LCD screen 20 is provided at the front cover 11 in such a manner that the LCD screen 20 is substantially aligned with a front side of the front cover 11 so as to minimize a thickness of the present invention.

According to the preferred embodiment, the LCD screen 20 is embodied as having a matrix view angle of 130v/140h, contrast of 450 to 1, brightness of 400 lumens, response of less than 25, and that the height and the tilt of the images shown are adjustable. The resolution of the LCD screen 20 is preferably 1280×768 for a 17″ LCD screen 20, having maximum color depth of 16.7 millions colors.

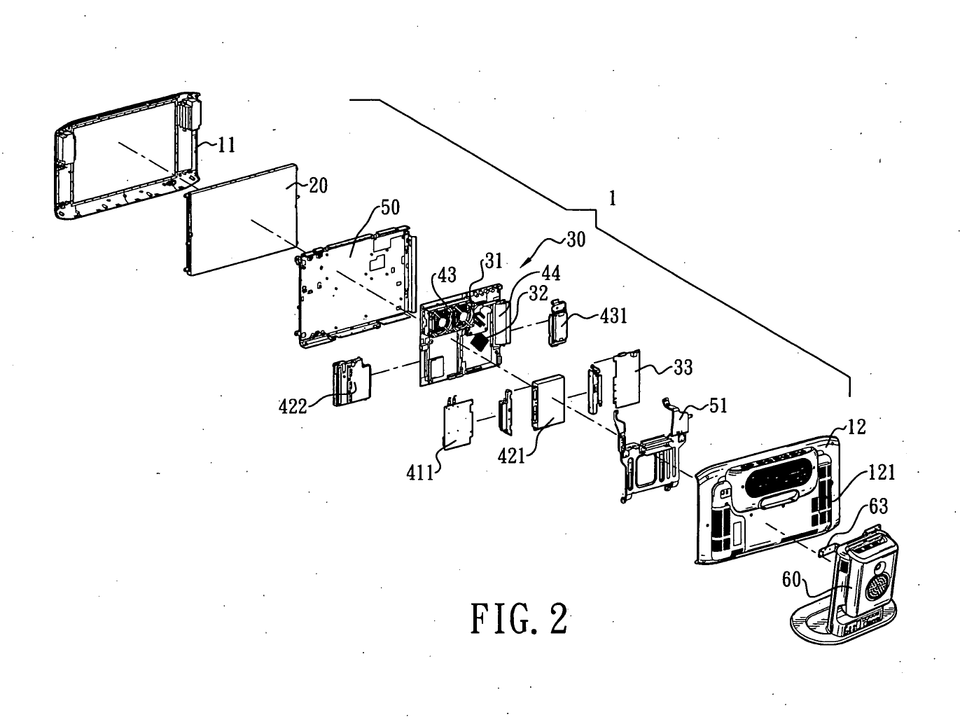

Referring to FIG. 2 of the drawings, the central control unit 30 comprises a main board 31 and a Central Processing Unit 32 (CPU) electrically coupled with the main board 31. According to the preferred embodiment, the CPU 32 is embodied as a high speed processor, such as Intel Pentium 4 or Celeron Processors. On the other hand, the computer board is embodied as a typical high-speed computer mother board, such as that using a chipset of Intel 82865 GMCH or ICH 5, having a front side bus of 400/533/800 MHz speed. Moreover, the main board 31 should be incorporated with a predetermined amount of adjustable on board memory for the computer system to operate, such as having a 256 MB DDR SDRAM.

The central control unit 30 further comprises a video processing unit 33 electrically connected with the main board 31 and is preferably embodied as a video display card for enabling an image to be displayed on the LCD screen 20. According to the preferred embodiment, the video processing unit 33 is preferably embodied as a typical display card of an Intel Integrated Graphics with 64 MB shared memory buffer, or ATI RADEON 9200 AGP Graphics with 128 MB independent memory buffer.

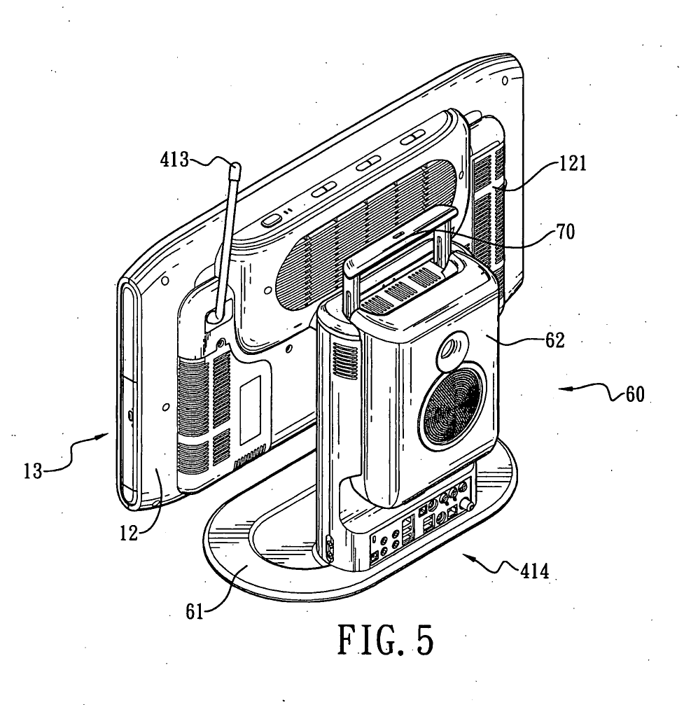

The TV-tumer hardware 411 of the TV device 41 is preferably embodied as a TV turner card electrically connected with the central control unit 30, wherein the TV device 41 further comprises a TV receiver 413 extended on the media housing 10 and electrically connected with the TV turner hardware for wirelessly receiving a TV broadcast signal through wireless board-casting network provided by at least one local TV service provider. According to the preferred embodiment, the TV receiver 413 is preferably embodied as a regular TV antenna adapted for receiving TV broadcast signal of a predetermined range of frequency. Moreover the TV device 41 further has a plurality of signal ports 414 (as shown in FIG. 5) provided on the media housing 10 for receiving and outputting TV signal from and to an external source, such as another television.

Furthermore, the two speakers 412 of the TV device 41 are mounted on the media housing 10 for delivering sound. They are preferably embodied as two typical speakers with Sub-5 Watts per channel supporting Windows Volume control.

On the other hand, the hard drive 421 of the computer device is preferably embodied as a typical hard disk for computers, a desirable example being standard 3.5″ desktop form-factor (up to 7200 RPM).

The removable memory drive 422 is preferably embodied as a DVD drive or a CD drive or a CD-RW drive which is installed along the functional rim 13 of the media housing 10 and is adapted to communicate with an outside thereof in such a manner that a user of the present invention is able to retrieve or to load a particular CD or DVD into or out of the removable memory drive 422.

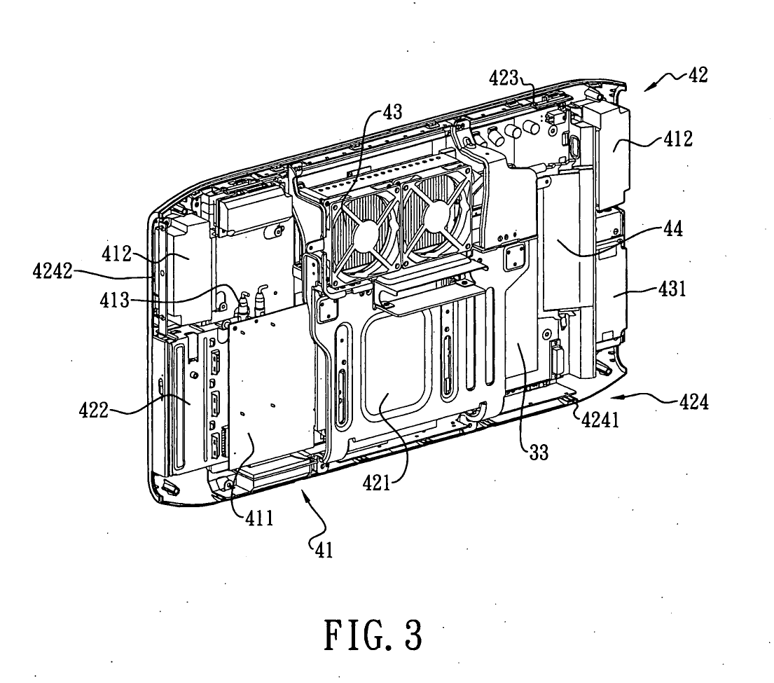

Referring to FIG. 2 to FIG. 3 of the drawings, the computer device 42 further comprises a network device 423 which is preferably embodied as a transmission modem card which is electrically provided on the main board 31, and has a network port provided on the functional rim 13 of the media housing 10 which is adapted to be transmitted to an external network provider, such as an Internet service provider, so as to connect to, for example, Internet service. In other words, the multi-media center 1 is capable of connecting into the Internet or any other form of computer networks through the network device 423. An example for this transmission modem is standard 56K data transfer/fax modem.

Alternatively, the network device 423 may be embodied as a Local Area Network (LAN) card for connecting with the Internet through broadband cable connected to the network port. An example of this LAN card is Integrated Intel 10/100 and option for integrated 802.11 g wireless Ethernet.

Yet another alternative is that the network device 423 may comprises both the LAN card and the transmission modem for connecting the multi-media center 1 with a predetermined network in a freely selectable manner. In other words, depending on the circumstances in question, the user of the present invention may be free to choose either the transmission modem or the LAN card for network or Internet connection.

Referring to FIGS. 2, 3, and 4 of the drawings, the rear cover 12 of the media housing 10 further has a detachable cover opening formed thereon wherein two or many memory slots such as dual or single channel DDR SDRAM slots 44 and a PCI card slot are electrically connected with the mother board 31, mounted on the mother board 31 with a predetermined slanting angle, and communicated with an exterior of the media housing 10 through the detachable cover opening. According to the preferred embodiment, a memory such as a SDRAM or a PCI card can be easily replaced through the detachable cover opening. In addition, the rear cover 12 of the media housing 10 further has a detachable cover 121 which is used to secure the detachable cover opening. However, the detachable cover 121 could be detachable from the detachable cover opening so that the SDRAM or the PCI card can be easily replaced through the detachable cover opening.

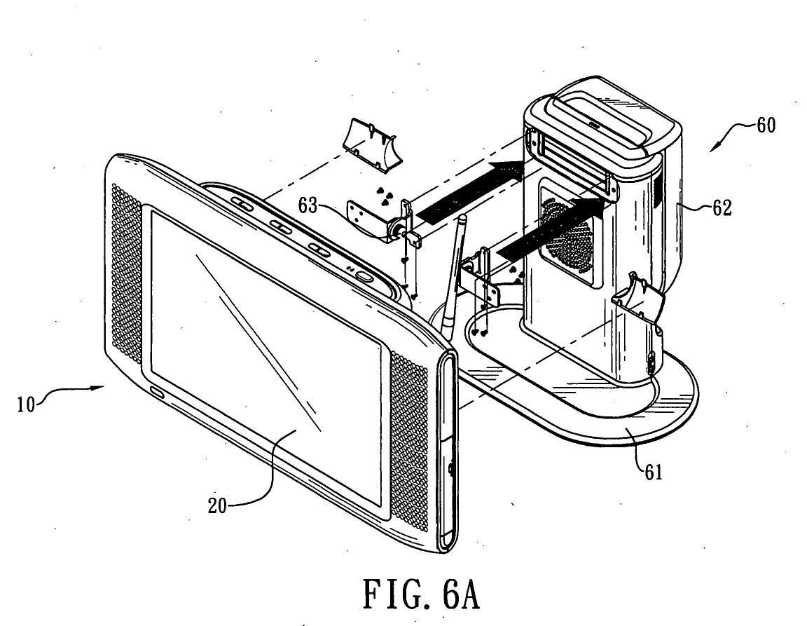

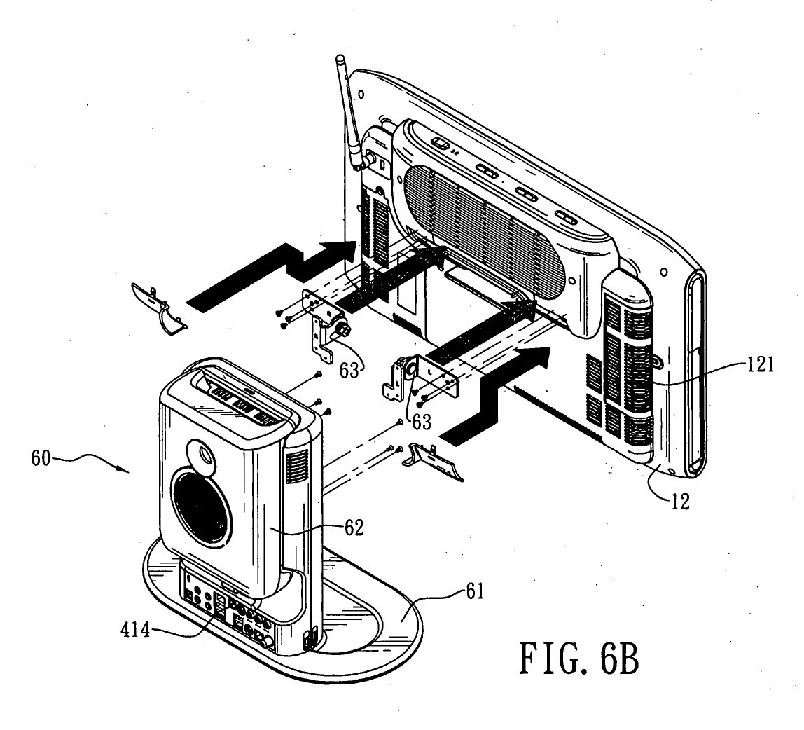

Referring to FIGS. 5, 6A, and 6B of the drawings, the multi-media center 1 further comprises a supporting stand 60 mounted on the rear cover 12 of the media housing 10 in a pivotally movable manner, and downwardly extended to suspendedly support the media housing 10 on a flat surface, such as a tabletop surface.

Specifically, the supporting stand 60 comprises a stand base 61, a supporting arm 62 transversely extended therefrom, and a pivotal hinge 63 connecting between the media housing 10 and the supporting arm 62 in a pivotally movable manner so as to suspendedly support the media housing 10 in the above-mentioned pivotally movable manner. Furthermore, the pivotal hinge 63 is connected to the hinge supporting frame 51 in the above-mentioned pivotally movable manner.

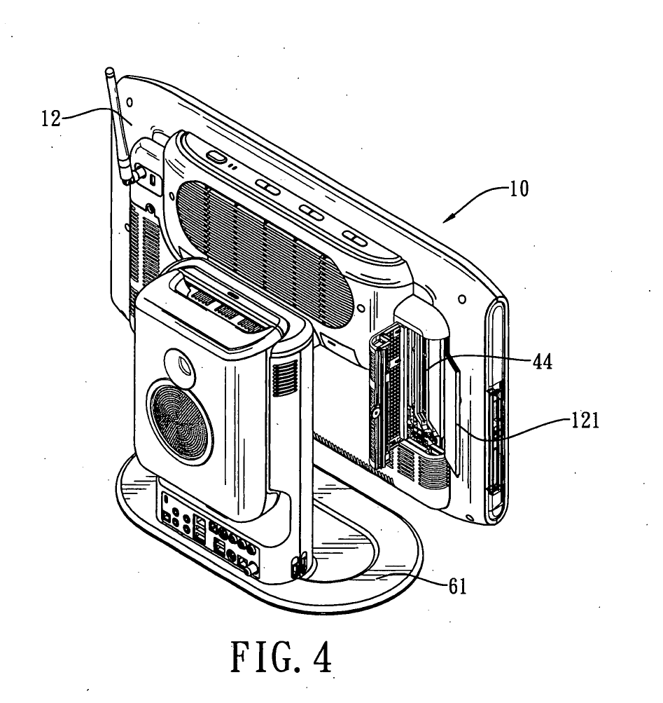

According to the preferred embodiment, the supporting stand 60 may also be electrically connected with the central control unit 30 wherein the plurality of signal ports 414, may be instead provided on a rear side of the supporting stand 60 for connecting with an external multi media device, such as another TV or a microphone, for signal sharing or transmission, such as that shown in FIG. 4 of the drawings. For example, a microphone may be electrically connected with the supporting stand 60 for, say Karaoke purpose. Furthermore, the network port of the network device 423 may also be extended to form on the supporting stand 60 instead of the media housing 10.

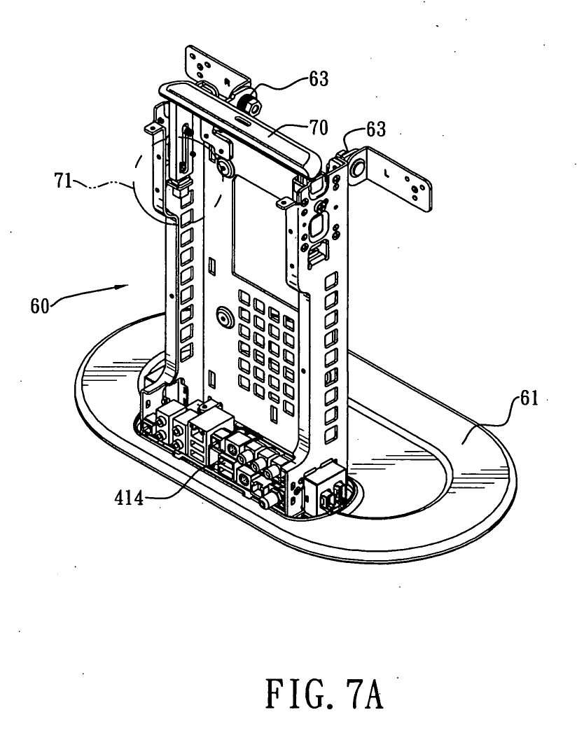

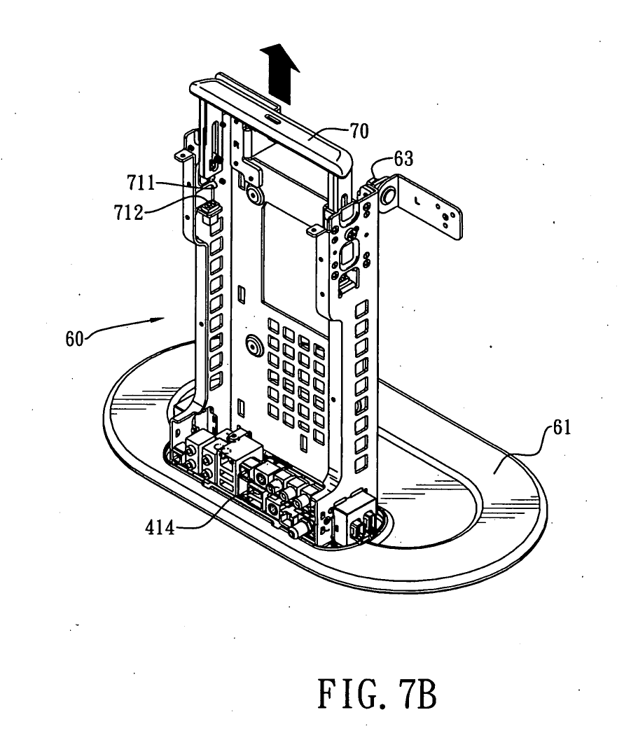

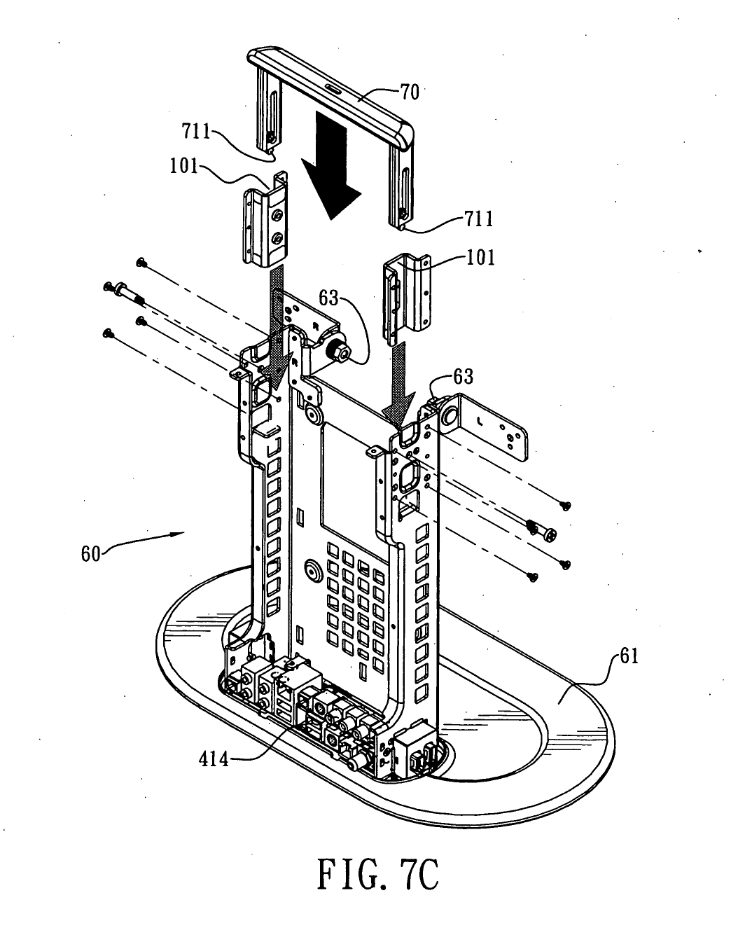

Referring to FIGS. 5, 7A, 7B, and 7C of the drawings, the all-in-one multi-media center 1 further comprises a hand-carrying device 70, which is embodied as an extendable handle movable extended from the supporting stand 60.

Accordingly, the hand-carrying device 70 extendably mounted to the supporting stand 60, wherein the supporting stand 60, which is constructed to form a portable compact unit, has a receiving cavity 101 to receive the hand-carrying device 70 such that the hand-carrying device 70 is adapted to move between a receiving position that the hand-carrying device 70 is totally received in the receiving cavity 101 in a hidden manner and a carrying position that the hand-carrying device 70 is upwardly extended above the media housing from the receiving cavity.

In other words, in the receiving position, the hand-carrying device 70 is movably received in the supporting stand 60 so as to minimize the occupying space of the present invention, and in the carrying position, the hand-carrying device 70 is fully extended to longitudinally erect on the supporting stand 60 so that a user may be able to carry the multi-media center 1 conveniently by the hand-carrying device 70.

The hand-carrying device 70 further comprises a door lock mechanism 71, wherein the door lock mechanism 71 has a protuberating member 711 and a chassis member 712. In the carrying position, the protuberating member 711 and the chassis member 712 are locked together so that the door lock mechanism 71 could be used to fix the hand-carrying device 70 in the receiving position. A user may be able to press down the hand-carrying device 70 and then the hand-carrying device 70 will be released from the receiving position so that the protuberating member 711 and the chassis member 712 are unlocked together. Therefore, the hand-carrying device 70 could be movably and fully extended to longitudinally erect on the supporting stand 60 so that a user may be able to carry the multi-media center 1 conveniently by the hand-carrying device 70.

Furthermore, referring to FIG. 3 of the drawings, the all-in-one multi-media center further comprises a wireless input device 424 to selectively control the TV device 41 and the computer device 42, wherein the input device 424 comprises a wireless receiver 4241 electrically connected with the central control unit 30 and a wireless controller 4242 wirelessly communicating with the wireless receiver 4241 to selectively operate the TV device 41 and the computer device 42 in a wireless manner.

Accordingly, the wireless receiver 4241 is embodied as a remote sensor provided on the media housing 10 to electrically connect with the central control unit 30, and the wireless controller 4242 is embodied as a wireless keyboard and/or a wireless mouse wirelessly communicated with the central control unit 30 via the remote sensor of the wireless receiver 4241 to operate the TV device 41 and the computer device 42 in a wireless manner.

Referring to FIG. 2 and FIG. 3 of the drawings, the multi-media arrangement further comprises a cooling device 43 mounted in the receiving compartment of the media housing 10 and communicated with an outside thereof for substantially removing heat generated in the media housing 10 to the outside so as to ensure an operation performance of the present invention as an electronics appliance.

Specifically, the cooling device 43 comprises at least one heat removal fan mounted at a top portion of the media housing and at a position adjacent to the central control unit 30 and the hard drive 421 which are typically identified as generating substantial amount of heat during normal operation. Thus in other words, the heat removal fan is adapted to remove the heat generated by them to an outside of the media housing. Accordingly, the rear cover 12 of the media housing 10 may further has a plurality of ventilating openings formed thereon for allowing the heat to be removed by convective heat transfers between the computer device 42 and the central control unit 30.

As an obvious alternative, the cooling device 43 may be embodied as at least one heat sink mounted on the media housing 10 and thermally communicated with the central processing unit 32 and the hard drive 421 for removing heat therefrom to an outside of the media housing 10.

Referring to FIG. 2 and FIG. 3 of the drawings, the supporting frame 50 is mounted in the receiving compartment and in itself arranged to mount the multi-media arrangement and the central control unit 30 in their respective predetermined position so as to form the above-mentioned compact structure and to minimize the thickness T of the media housing 10 so as to minimize the overall thickness and size of the present invention.

According to the preferred embodiment, the supporting frame 50 has a predetermined number of supporting slots formed thereon wherein each component are supported at a predetermined support slot for forming the compact structure of the present invention. As shown in FIG. 3 of the drawings, each of the components is specifically positioned so as to be compactly arranged in such a manner that a depth of the media housing 10 is to be minimized.

It is worth mentioning that the hard drive 421 is supported at the mid-bottom portion of the receiving compartment to electrically connect with the central control unit 30 so as to lower a center of gravity of the present invention, for the hard drive 421 is expected to be the heaviest electronics components in the receiving compartment.

Moreover, it is also important to point out that each of the components are overlappedly arranged and assembled in the media housing 10 in such a manner that they are oriented in a same planer direction so as to form the minimum thickness T of the media housing 10. Therefore, the present invention is capable of being neatly and compactly erected for operation, as well as lightly and conveniently carried or transported.

Preferably, the present invention should have a weight of approximately 30 lbs and a size of approximately 21″×16×10″, which should be substantially smaller than conventional desktop computers or TVs.

One skilled in the art would then appreciate that the above-mentioned invention is capable of performing a wide variety of multi-media tasks for bring the user maximum entertainment effect.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An all-in-one multi-media center, comprising:
a media housing having a front side, a rear side, and a functional rim extended between a peripheral edge of said front side and a peripheral edge of said rear side to form a receiving compartment within said front side, said rear side and said functional rim, wherein said receiving compartment has a thickness between said front and said rear side;
a LCD screen provided at said front side of said media housing to define a planar direction;
a central control unit supported within said receiving compartment to electrically connect to said LCD screen at said planar direction;
a multi-media arrangement comprising a TV device and a computer device;
wherein said TV device comprises a television-tuner hardware, which is supported within said receiving compartment to electrically connected with said central control unit for processing television signal such that said central control unit is adapted for converting said television signal into an image signal to be displayed on said LCD screen, and two speakers supported at two side portions of said receiving compartment to electrically connect with said central control unit for converting said television signal into a sound signal;
wherein said computer device comprises a hard drive supported at a mid-bottom portion of said receiving compartment to electrically connect with said central control unit and a removable memory drive supported on one of said side portion of said receiving compartment to electrically connect with said central control unit, wherein removable memory drive has an access slot formed on said functional rim for allowing a memory disc communicating with said removable memory drive through access slot; and
a supporting frame supported within said receiving compartment at a position between said LCD screen and said central control unit to substantially support said TV device and said computer device within said receiving compartment in a compact unit so as to minimize said thickness of said media housing between said front and rear sides thereof.

2. The all-in-one multi-media center, as recited in claim 1, further comprising a cooling device supported within said receiving compartment at a position right above said hard drive such that said cooling device is adapted for substantially dispersing heat from said hard drive within said receiving compartment.

3. The all-in-one multi-media center, as recited in claim 2, wherein said media housing has a plurality of ventilating openings formed at said rear side of said media housing to align with said cooling device for effectively dispersing said heat within said receiving compartment to an exterior of said media housing.

4. The all-in-one multi-media center, as recited in claim 1, wherein said thickness of said media housing is less than 10 inches.

5. The all-in-one multi-media center, as recited in claim 1, wherein said central control unit comprises a main board supported within said receiving compartment at said planar direction with respect to said LCD screen and a central processing unit electrically coupled with said main board to control said TV device and said computer device.

6. The all-in-one multi-media center, as recited in claim 1, further comprising a wireless input device to selectively control said TV device and said computer device, wherein said input device comprises a wireless receiver electrically connected with said central control unit and a wireless controller wirelessly communicating with said wireless receiver to selectively operate said TV device and said computer device in a wireless manner.

7. The all-in-one multi-media center, as recited in claim 1, further comprising a detachable cover opening formed on said rear side of said media housing, wherein at least one slot is electrically connected with said central control unit, mounted on said central control unit with a predetermined slanting angle, and communicated with an exterior of said media housing through said detachable cover opening so that a memory is easily replaced through said detachable cover opening.

8. The all-in-one multi-media center, as recited in claim 7, further comprising a detachable cover which is used to secure said detachable cover opening.

9. The all-in-one multi-media center, as recited in claim 7, wherein said slot is selected from a group consisting of dual channel DDR SDRAM slots, a single channel DDR SDRAM slot, and a PCI card slot.

10. The all-in-one multi-media center, as recited in claim 1, further comprising a hand-carrying device foldably mounted to said media housing, wherein said media housing, which is constructed to form a portable compact unit, has a receiving cavity to receive said hand-carrying device such that said hand-carrying device is adapted to move between a receiving position that the hand-carrying device is totally received in said receiving cavity in a hidden manner and a carrying position that said hand-carrying device is upwardly extended above said media housing from said receiving cavity.

11. The all-in-one multi-media center, as recited in claim 10, further comprising a supporting stand for substantially support said media housing in a suspending manner, wherein a plurality of signal ports are formed at said supporting stand to electrically connect with said central control unit and said multi-media arrangement such that said central control unit and said multi-media arrangement are adapted for connecting an external multi-media device via said signal ports.

12. The all-in-one multi-media center, as recited in claim 10, wherein said TV-turner hardware comprises a TV turner card electrically connected with said central control unit, wherein said TV device further comprises a TV receiver extended on said media housing and electrically connected with said TV turner hardware for wireless receiving a TV broadcast signal through an external wireless broadcasting network.

13. The all-in-one multi-media center, as recited in claim 10, wherein said central control unit further comprises a video processing unit, which is formed as a video display card, electrically connected with said main board for enabling an image to be displayed on said LCD screen.

14. The all-in-one multi-media center, as recited in claim 10, wherein said computer device further comprises a network device which is supported in said media housing and electrically connected with said central control unit, and has a network port extended for connecting with an external network provider.
